(19) United States
(12) Patent Application Publication
(10) Pub. No.: US 2005/0056061 A1
(43) Pub. Date: Mar. 17, 2005

(54) Locking safety latch for pool fence

(76) Inventor: Michael Schatzberg, Coral Springs, FL (US)

Correspondence Address: SCOTT L. LAMPERT;LAW PRACTICE OF SCOTT L. LAMPERT, P.A., P.O. BOX 813449, HOLLYWOOD, FL, 33081-3449, US

(21) Appl. No.: 10/662,241

(22) Filed: Sep. 16, 2003

(51) Int. Cl. E05B 73/00; E05B 65/06

(52) U.S. Cl. 70/18; 70/101

(57) ABSTRACT

A locking safety latch for a tensioned fence of the type comprising a plurality of spaced apart poles having a lower end secured to the ground, a mesh screening material stretched between the poles and a pair of adjacent gate poles, with no mesh screening material therebetween, which may be lifted out of the ground and swung to the side to provide a “gate” opening. The locking safety latch comprises a first screw eyelet, with its screw end secured to one of the gate poles, a second screw eyelet, with its screw end secured to the second gate pole, and a hook member, with a first ring-shaped end in mating engagement with the eyelet end of the second screw eyelet, and a generally L-shaped arm extending out from the first ring-shaped end. The outer distal end of the L-shaped arm includes a second ring-shaped end structured (i) to be inserted through the eyelet end of the first eyelet member and (ii) to receive the arm of a padlock therethrough. In use, the second ring-shaped end of the hook member is inserted through the eyelet of the first eyelet member, the arm of the padlock is then inserted through the second ring-shaped end and the padlock is then locked so that the second ring-shaped end cannot be lifted out of eyelet of the eyelet member, thereby locking the latch and preventing the “gate” from being opened.

### BACKGROUND OF THE INVENTION

1. Field of the Invention

The present invention relates to safety latches and, more particularly, to a safety latch for a pool fence structured to accommodate an external lock.

2. Description of the Related Art

The use of removable tensioned fences has increased greatly over the past several years. Such fences are typically used to enclose a swimming pool or other hazard, and are intended to prevent access to such swimming pools or hazards by small children.

In general, these fences are comprised of a plurality of spaced apart poles, having a lower end inserted into holes in the deck around the swimming pool, and a mesh screening material stretched between such poles. One or more so called “gates” are provided in the fence assembly by placing two of the poles immediately adjacent one another, with no mesh tensioned between such poles. A simple hook and eye latch is usually included to latch the two poles to one another to prevent small children from accessing the swimming pool. For further child safety, a hook and eye latch with a spring-loaded tang, tensioned to prevent opening by a child, is used.

To open this “gate” structure, the user (i) forces the two poles together to lessen the lateral tension on the latch from the tensioned mesh screening material attached to the poles, (ii) unlatches the latch by lifting the hook out of the eye, (iii) pulls one of the poles out of its hole, and (iv) swings the removed pole and attached mesh to the side to provide an opening to the swimming pool. To close this “gate”, the user (i) swings the removed pole and attached mesh back to the hole in the deck from where it was removed, (ii) inserts the lower end of the pole into the hole, (iii) forces the two adjacent poles together and (iv) inserts the hook into the eye to relatch the latch.

Although somewhat effective for its intended purpose, this prior art structure has not proven to be entirely satisfactory. Specifically, the mere inclusion of a hook and eye latch to retain the two adjacent gate poles together is not, by itself, adequate to prevent children from opening the gate and accessing the swimming pool. The child or children only need to slide the hook up out of the eye to unlatch the two adjacent poles and gain access to the swimming pool. Although somewhat more effective, the use of a spring-loaded tang with the hook and eye latch has also not proven to be entirely satisfactory because the spring tension is oftentimes not great enough to prevent children from sliding the tang and lifting the hook out of the eye.

Accordingly, there is still a need in the art for a safety latch which may not be unlatched by children or others for whom access to the swimming pool is not desired. Any such latch should be structured to accommodate an external lock which prevents the latch from being unlatched as long as the external lock is locked. The present invention is particularly suited to overcome those problems which remain in the art in a manner not previously known.

### SUMMARY OF THE INVENTION

The present invention is directed towards a new and improved locking safety latch for a tensioned fence of the type comprising a plurality of spaced apart poles having a lower end secured to the ground, a mesh screening material stretched between the poles and a pair of adjacent gate poles, with no mesh screening material therebetween, which may be lifted out of the ground and swung to the side to provide a “gate” opening. The locking safety latch comprises a first screw eyelet, with its screw end secured to one of the gate poles, a second screw eyelet, with its screw end secured to the second gate pole, and a hook member, with a first ring-shaped end in mating engagement with the eyelet end of the second screw eyelet, and a generally L-shaped arm extending out from the first ring-shaped end. The outer distal end of the L-shaped arm includes a second ring-shaped end structured (i) to be inserted through the eyelet end of the first eyelet member and (ii) to receive the arm of a padlock therethrough. In use, the second ring-shaped end of the hook member is inserted through the eyelet of the first eyelet member, the arm of the padlock is then inserted through the second ring-shaped end and the padlock is then locked so that the second ring-shaped end cannot be lifted out of eyelet of the eyelet member, thereby locking the latch and preventing the “gate” from being opened.

It is an object of the present invention to provide a new and improved safety latch which has all the advantages of the prior art devices and none of the disadvantages.

It is another object of the present invention to provide a safety latch for use with child safety fences.

It is also an object of the present invention to provide such a latch which may not be unlatched by children or others for whom access to a swimming pool or other area is not desired

It is a further object of the present invention to provide such a latch which is structured to accommodate an external lock to prevent the latch from being unlatched as long as the external lock is locked.

It is yet a further object of the present invention to provide such a latch which may be used with any existing fence.

It is yet another object of the present invention to provide such a latch which may be used with any other structure or for any other use for which a hook and eye latch may be used.

These and other objects and advantages of the present invention will become more readily apparent in the description which follows.

### BRIEF DESCRIPTION OF THE DRAWINGS

For a fuller understanding of the nature of the present invention, reference should be had to the following detailed description, taken in connection with the accompanying drawings in which:

FIG. 1 is a perspective view of the tensioned fence of the present invention.

FIG. 2 is a front plan view of the tensioned fence with locking safety latch of the present invention, in partial section.

FIG. 3 is side elevation view of the locking safety latch of the present invention.

FIG. 4 is top plan view of the locking safety latch of the present invention.

Like reference numerals refer to like parts throughout the several views of the drawings.

### DETAILED DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

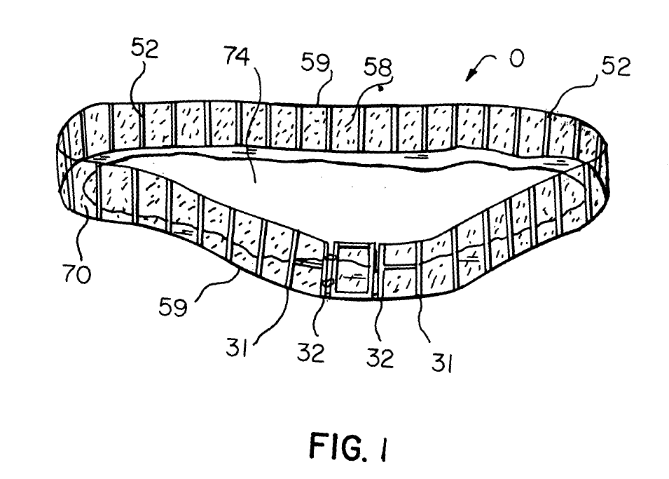

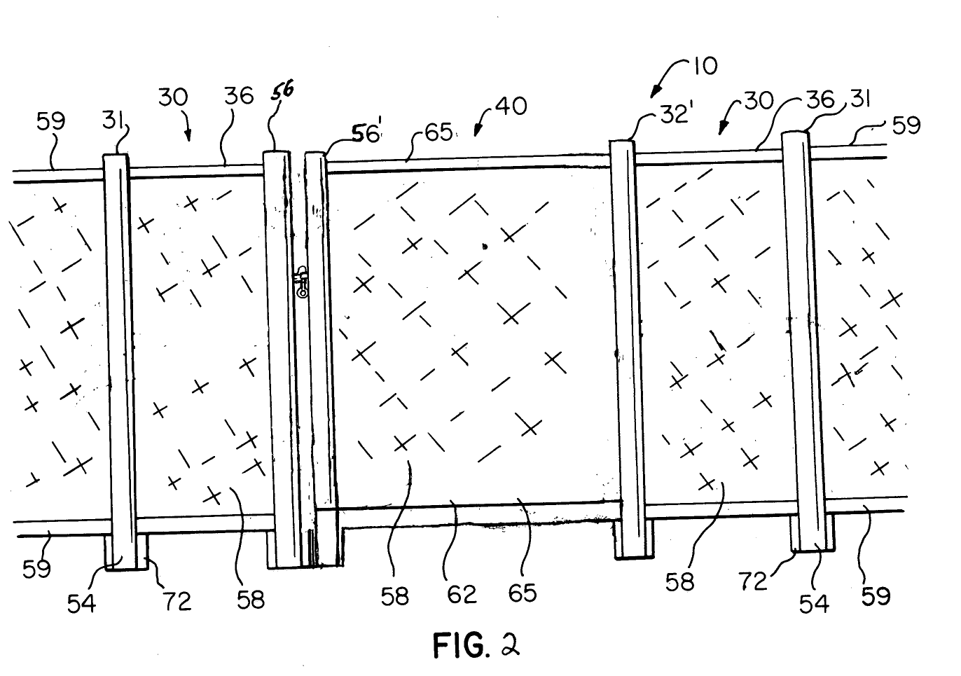

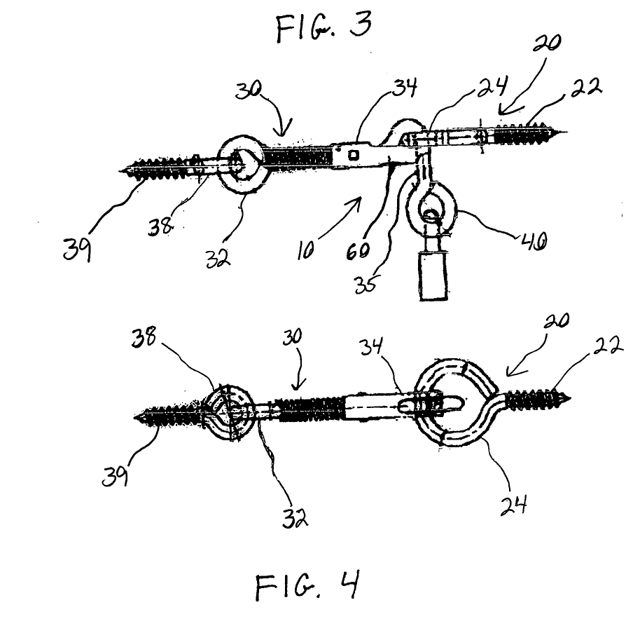

As shown in FIGS. 1-4, the present invention is directed towards a new and improved locking safety latch 10 for a swimming pool fence 50. The fence 50 is of the type comprising a plurality of spaced apart poles 52, having a lower end 54 inserted into holes 72 drilled in the deck 70 around the swimming pool 74, and a mesh screening material 58 stretched between the poles 52. The tension applied to the poles 52 by the mesh material 58 force the poles 52 into a generally vertical position in the holes 72 and provides structural stability to the resultant tensioned fence assembly 50.

One or more “gates” are provided in the fence assembly 50 by positioning two gate poles 56, 56′ immediately adjacent one another, with no mesh tensioned between these gate poles 56, 56′. The gates are opened by lifting one of the gate poles 56 out of its hole 72 and swinging the removed gate pole 56 and attached mesh 58 to the side to provide an opening to access the swimming pool 74. To close the gate, the removed pole 56 and attached mesh 58 is swung back towards the hole 72 in the deck 70 from where it was removed and the lower end 54 of the pole 56 is inserted into the hole 72 in the deck 70.

The locking safety latch 10 comprises a first eyelet member 20 and a hook member 30. The first eyelet member 20 is a conventional screw eyelet having an externally threaded screw end 22 and an opposite eyelet end 24. The screw end 22 of the first eyelet member 20 is secured to one of the gate poles 56′ so that the eyelet end 24 extends outward from the gate pole 56′ in the general direction of the adjacent gate pole 56.

The hook member 30 includes a first ring-shaped end 32 and a generally L-shaped arm 34 extending out from said first ring-shaped end 32. A second eyelet member 36 includes an eyelet end 38 in mating engagement with the ring-shaped end 32 of the hook member 30 and an opposite externally threaded screw end 39 secured to the second gate pole 56. The outer distal end of the L-shaped arm 34 includes a second ring-shaped end 40 structured (i) to be inserted through the eyelet end 24 of the first eyelet member 20 and (ii) to receive the arm of a padlock therethrough.

The L-shaped arm 34 is structured for swinging movement from a first latched position, wherein the second ring-shaped end 40 of the L-shaped arm 34 has been inserted through the eyelet end 24 of the first eyelet member 20, thereby securing the adjacent gate poles 56, 56′ to one another, to a second unlatched position, wherein the second ring-shaped end 40 of the L-shaped arm 34 has been removed from the eyelet end 24 of the first eyelet member 20 so that the gate poles 56, 56′ may be separated from one another and the gate opened.

In use, the second ring-shaped end 40 of the hook member 30 is inserted through the eyelet end 24 of the first eyelet member 20 in the same manner as a conventional hook and eye latch. The arm of the padlock is then inserted through the second ring-shaped end 40 and the padlock is locked. With the padlock locked on the second ring-shaped end 40, the second ring-shaped end 40 cannot be lifted out of eyelet end 24 of the first eyelet member 20. Thus, the latch 10 is locked and the “gate” cannot be opened without unlocking and removing the padlock.

The padlock may be of any type known in the art, including, but not limited to, combination padlocks and key padlocks. It should be appreciated that any other type of locking device capable of mating with the outer distal end of the L-shaped arm 34 after it has been inserted through the eyelet end 24 of the eyelet member 20 and preventing such outer distal end from being lifted out of the eyelet end 24 of the eyelet member 20 may, alternatively, be employed.

A spring-loaded tang 60 may also be included on the L-shaped arm 34 of the hook member 30 as an additional safety feature in the event no lock is used or the lock is not properly secured to the second ring-shaped end 40. In this embodiment, the spring is biased to force the tang 60 towards the leg 35 of the L-shaped arm 34, which is inserted through the second ring-shaped end 40. The spring tension is preferably great enough so that a child cannot slide the tang 60 and lift the leg 35 of the L-shaped arm 34 out of the second ring-shaped end 40.

While the locking safety latch 10 of the present invention is described herein for use with a tensioned child safety fence, it should be appreciated that it may be used for any use for which a conventional hook and eye latch may be used. For instance, it may be used on doors, cabinets or any other structure where access to children or others is not desired.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

1. A locking safety latch for securing a pair of adjacent gate poles in a tensioned fence having a plurality of spaced apart poles and a mesh screening material stretched between the spaced apart poles, the latch comprising:
a first eyelet member having a first end secured to a first one of the gate poles and an opposite eyelet end;
a lock; and
a hook member having a first end secured to a second one of the gate poles and a generally L-shaped arm extending out from said first end, said L-shaped arm including an outer distal end structured (i) to be removably inserted through said eyelet end of said first eyelet member and (ii) to mate with said lock so that said outer distal end is secured within said eyelet end of said first eyelet member.

2. A locking safety latch as recited in claim 1, wherein said first end of said first eyelet member is externally threaded and structured to be screwed into said first one of the gate poles.

3. A locking safety latch as recited in claim 1, further comprising a second eyelet member having a first end secured to said second one of the gate poles and an opposite eyelet end structured to mate with said first end of said hook member.

4. A locking safety latch as recited in claim 1, wherein said outer distal end of said L-shaped arm is substantially ring-shaped.

5. A locking safety latch as recited in claim 4, wherein said lock is a padlock.

6. A locking safety latch as recited in claim 1, wherein said L-shaped arm further includes a spring-loaded tang biased towards said outer distal end.

7. A locking safety latch for securing a pair of adjacent gate poles in a tensioned fence having a plurality of spaced apart poles and a mesh screening material stretched between the spaced apart poles, the latch comprising:
a first eyelet member having a first end secured to a first one of the gate poles and an opposite eyelet end;
a second eyelet member having a first end secured to a second one of the gate poles and an opposite eyelet end;
a lock; and
a hook member having a first end structured to mate with said eyelet end of said second eyelet member and a generally L-shaped arm extending out from said first end, said L-shaped arm including a substantially ring-shaped outer distal end structured (i) to be removably inserted through said eyelet end of said first eyelet member and (ii) to mate with said lock so that said outer distal end is secured within said eyelet end of said first eyelet member.

8. A locking safety latch as recited in claim 7, wherein said first end of said first eyelet member is externally threaded and structured to be screwed into said first one of the gate poles.

9. A locking safety latch as recited in claim 7, wherein said lock is a padlock.

10. A locking safety latch as recited in claim 7, wherein said L-shaped arm further includes a spring-loaded tang biased towards said outer distal end.

11. A method of locking a safety latch to a pair of adjacent gate poles in a tensioned fence, the safety latch having a first eyelet member secured to one of the gate poles, a second eyelet member secured to the second gate pole, a lock and a hook member having a first end attached to the second eyelet member and a generally L-shaped arm extending out from the first end, the method comprising:
a) inserting the outer distal end of the L-shaped arm through the first eyelet member; and
b) securing the lock to the outer distal end.

12. A method of locking a safety latch to a pair of adjacent gate poles in a tensioned fence as recited in claim 11, wherein the outer distal end of the L-shaped arm is substantially ring-shaped.

13. A method of locking a safety latch to a pair of adjacent gate poles in a tensioned fence as recited in claim 12, wherein the lock is a padlock having an arm structured for insertion through the substantially ring-shaped outer distal end of the L-shaped arm.

14. A locking safety latch comprising:
a first eyelet member having a first end secured to a first structure and an opposite second eyelet end;
a lock; and
a hook member having a first end secured to a second structure and a generally L-shaped arm extending out from said first end, said L-shaped arm including an outer distal end structured (i) to be removably inserted through said eyelet end of said first eyelet member and (ii) to mate with said lock so that said outer distal end is secured within said eyelet end of said first eyelet member.

15. A locking safety latch as recited in claim 14, wherein said first end of said first eyelet member is externally threaded and structured to be screwed into said first one of the gate poles.

16. A locking safety latch as recited in claim 14, further comprising a second eyelet member having a first end secured to said second one of the gate poles and an opposite eyelet end structured to mate with said first end of said hook member.

17. A locking safety latch as recited in claim 14, wherein said outer distal end of said L-shaped arm is substantially ring-shaped.

18. A locking safety latch as recited in claim 17, wherein said lock is a padlock.

19. A locking safety latch as recited in claim 14, wherein said L-shaped arm further includes a spring-loaded tang biased towards said outer distal end of said L-shaped arm.
